(19) United States
(12) Patent Application Publication
(10) Pub. No.: US 2011/0248846 A1
(43) Pub. Date: Oct. 13, 2011

(54) Wireless Sensing Module and Method of Operation

(75) Inventors: Nickolai Belov, Los Gatos, CA (US); Ghassan Tchelepi, Los Altos, CA (US)

(73) Assignee: Green SHM Systems, Inc, Incorporated, Los Gatos, CA (US)

(21) Appl. No.: 12/758,886

(22) Filed: Apr. 13, 2010

(51) Int. Cl. G08B 1/08

(52) U.S. Cl. 340/539.1

(57) ABSTRACT

A wireless sensing module with extended service life containing at least one sensor of a physical parameter, a data acquisition hardware acquiring output electrical signals from at least one sensor and converting it into digital measurement data, a microcontroller, a non-volatile memory, at least one transceiver for wireless communication with external wireless devices, at least one battery, including at least one re-chargeable battery, at least one energy harvesting device, a power management circuit, and at least one antenna. All components of the wireless sensing module are mounted on a printed circuit board and placed into an enclosure providing mechanical, chemical, electrical and environmental protection. The wireless sensing modules can be used in different applications, including long-term condition monitoring of structures.

### BACKGROUND

1. Field of the Invention

This invention is related to wireless sensors and, more specifically, to wireless sensing modules with extended service life. The wireless sensing modules can be used in different applications, including long-term monitoring of structures and environmental monitoring.

2. Description of Related Art

Wireless sensors are currently being used in a wide range of applications and new application areas are emerging every year. One of the greatest advantages of wireless sensors is related to their ability to transfer measurement data and/or processed information via wireless links making wired connections to the sensors unnecessary. Using wireless communications greatly reduces the cost of sensor installation, allows for placing sensors on moving objects, for example, on rotating parts of machines, implanting them in live objects, etc. In most applications where wireless sensors are being used it is important not to have power delivered to the sensors from a local power line. It is preferable to have wireless sensors powered by batteries, by energy harvesting devices or by combination of these two methods.

There are many patents related to wireless sensors and applications where these sensors can be used. Some of them are incorporated in this patent application as references. In particular, U.S. Pat. No. 7,408,452 “Wireless wheel speed sensor” to Knitti describes wireless sensors for wheel speed measurements. U.S. Pat. No. 7,425,200 “Implantable sensor with wireless communication” to Brockway et al. describes implantable wireless sensors for blood pressure measurements. U.S. Pat. No. 6,292,108 “Modular, wireless damage monitoring system for structures” to Straser et al. describes wireless sensors that can be used for damage detection of structures.

One of the most important parameters of wireless sensors is their service life. As wireless sensors can be installed in hard-to-get places, their maintenance can be expensive. For example, wireless sensors can be used for monitoring of structures. Replacing batteries or other maintenance of wireless sensors may require a service trip to the monitored structure and using special equipment to get to the places where the sensors are installed. Sensor service life of 10-15 years is desirable in many applications. However, even if current consumption is as small as 1 mA and the sensor has two D-size batteries with total capacity of 40,000 mAh then the sensor will consume all the energy within 40,000 hours or approximately 4.5 years. In reality, the radio typically consumes much larger current than 1 mA. Consequently, service life of a wireless sensor with continuous operation is typically significantly shorter than 1 year and this is not acceptable in many application areas.

There are several ways to deal with the problem, including: (a) adding an energy harvesting device to the wireless sensor module; (b) adding intelligence to the wireless sensor module to allow for both active mode when measurements can be made and data can be transmitted and inactive power consumption mode when very little energy is consumed; (c) adding power management capabilities to the wireless sensor module or combination of the above. All these options have been reflected in patents related to wireless sensors.

Energy harvesting is a natural way to provide an additional energy to sensor nodes and extend their life. Many methods of energy harvesting have been explored, including harvesting of solar energy, thermal energy, mechanical energy, energy of wind, energy of radio waves, energy of radioactive particles and others. A good summary of energy harvesting methods can be found in several reviews. A reference to a recent review by N. Hudak and G. Amatucci can be found in the list of references. Several energy harvesting devices and materials for use in energy harvesting devices are commercially available as, for example, from Advanced Cerametrics Inc., Perpetuum Ltd., EnOcean Inc., Ferro Solutions Inc., Thermolife Energy Corporation, Smart Material, and some other. U.S. Pat. Nos. 7,081,693 “Energy harvesting for wireless sensor operation and data transmission” to Hamel et al. and 7,429,805 “Energy harvesting for wireless sensor operation and data transmission” to Hamel et al. describes a general approach that allows for implementing energy harvesting for powering a wireless sensor.

Unfortunately, efforts related to combining wireless sensors with energy harvesting devices did not yield any wireless sensing devices capable of operating for 10-15 years. There are several reasons for that. One is related to the small amounts of energy produced by the energy harvesting devices and some loss of harvested energy due to conditioning to a form suitable for use by wireless sensors. The other reason is related to insufficient attention to long-term reliability of the energy harvesting devices and the wireless sensors themselves in field conditions. Still another reason is related to the fact that wireless sensors should have large enough energy storage in order to use harvested energy effectively. Finally, energy harvesting should be combined with power management in order to minimize number of recharging cycles of the energy storage device and extend its service life and, therefore, the service life of the wireless sensor.

U.S. Pat. No. 7,142,107 “Wireless sensor unit” to Kates describes a wireless sensor with extended service life that sends out a wireless signal only when measured parameter moves out of a pre-determined range. This approach allows for a very significant power savings because the highest power consumption usually corresponds to modes with active radio. However, it also has significant disadvantages. The most important one is related to the fact that the sensor may stop functioning and it will not be detected. A related issue—significant long-term drift of sensor parameters also can not be detected. Besides that, power consumption by the sensor itself can be large enough to cause discharge of the battery within a relatively short period of time without the use of the radio. It is important to combine this approach with both energy harvesting and the use of sleep mode for the wireless sensor to minimize energy consumption.

U.S. Pat. No. 7,447,526 “Power-saving method for wireless sensor network” to Kim et al. describes a power-saving method, which includes switching between power-saving and receive-transmit modes. This approach can allow for a significant extension of wireless sensor service life. However, in many cases using of just this approach is not enough. In particular, if a wireless sensor consumes more than 0.1% of battery power per session and needs to have at least one session per day then its service life will be limited to approximately 3 years. However, adding an energy harvesting device that can compensate this energy loss opens an opportunity to extend service life of the wireless sensor.

These examples show that a combination of all the three methods mentioned above—(a) adding an energy harvesting device to the wireless sensor module; (b) adding intelligence to the wireless sensor module to allow for both active mode when measurements can be made and data can be transmitted and inactive power consumption mode when very little energy is consumed; (c) adding power management capabilities to the wireless sensor module—is necessary in order to achieve 10-15 years of service life of wireless sensors.

However, even when implementing all three methods of extending service life of wireless sensors, it is not enough to achieve 10-15 years of service life of wireless sensors if their components are not well protected mechanically, electrically, chemically and environmentally. Adequate protection of wireless sensors is another important requirement directly linked to their service life extension. Damage of wireless sensor components can result in failure of the wireless sensor. For example, an external antenna, external energy harvesting device or other external component of wireless sensor can be damaged as a result of interaction with mechanical objects, or damaged by birds, insects, or other animals or as a result of accumulation of dust. Batteries and other components can be damaged by water or moisture penetrating inside the enclosure. Moisture also can create conductive bridges between components or conductive lines on printed circuit board inside the wireless sensor enclosure. Other chemically active substances can also damage the wireless sensor if these substances interact with its components and/or printed circuit board. Mechanical damage of wireless sensor can cause parasitic electrical connections and result in electrical damage as well. These issues have not been addressed in the prior art.

None of the existing technical solutions meet all of the above discussed requirements for extending the service life of wireless sensors. As a result wireless sensors with service life of 10-15 years are not available for many applications, for example wireless sensors for structural health monitoring, environmental monitoring, border protection and others.

### SUMMARY

The present invention discloses wireless sensing modules with extended service life and method of operation. Wireless sensing modules according to the current invention are capable of operating for a long period of time because they harvest energy from the environment, utilize microcontrollers and employ algorithms, which allow for switching between an active mode, when measurements are made and when data is transmitted, and an inactive mode or sleep mode when little energy is consumed; incorporate power management capabilities, use components and assembly methods capable of providing a very long life time for the device, and provide adequate protection of the components from the environment.

Wireless sensing module with extended service life comprises a set of electrical components located in an environmental enclosure. The set of electrical components includes: at least one sensor of a physical parameter generating output electrical signals proportional to value of the physical parameter; data acquisition hardware acquiring output electrical signals from at least one sensor and converting it into digital measurement data; a microcontroller controlling the wireless sensing module by executing a code, receiving, processing and transferring the digital measurement data; non-volatile memory used by the microcontroller for storing the measurement data and the results of the measurement data processing; at least one transceiver for wireless communication with external wireless devices; at least one battery, including at least one rechargeable battery, providing electrical power to the electrical components of the wireless sensing module; at least one energy harvesting device for converting energy from the environment into electrical energy and generating an electrical voltage as a result; a power management circuit for charging of at least one rechargeable battery from at least one energy harvesting device; at least one antenna; and at least one printed circuit board. All electrical components are electrically connected to at least one printed circuit board. The environmental enclosure contains all electrical components and provides required mechanical, chemical, electrical and environmental protection of the electrical components.

A method of operation of a wireless sensing module includes the steps of providing the above described wireless sensing module; defining operating parameters, including timing and duration of measurement sessions for each sensor and its sampling rate, periodicity of data transmission, range of environmental conditions for wireless data transmission; providing a code for controlling the wireless sensing module and running the code. The code allows for executing of at least the following steps: putting the wireless sensing module into a power saving mode—sleep mode; waking up the microcontroller of the wireless sensing module; responding to external wireless signals; activating at least one sensor and data acquisition hardware; making measurements with at least one activated sensor and collecting both digitized results of measurements and supplemental information—raw measurement data; saving measurement data in the non-volatile memory; activating the transceiver; transmitting the measurement data; charging the at least one rechargeable battery. In order to minimize average power consumption and extend service life of the wireless sensing module the raw measurement data is pre-processed by the microcontroller and the volume of data transmitted by transceiver is reduced in comparison with the volume of raw measurement data. The pre-processing can include averaging of consecutive measurements, averaging of concurrent measurements made by different sensors, calculating average for a set of collected raw measurement data—offset, removing offset, introducing offset, applying temperature-related correction and other corrections to the raw measurement data, data compression, using error correction codes and their combination.

### BRIEF DESCRIPTION OF DRAWINGS

FIG. 1 shows a block diagram of a wireless sensing module.

FIG. 2 shows a block diagram of a wireless sensing module with sleep-mode clock and integrated digital sensor.

FIG. 3 shows a block diagram of a wireless sensing module with external components.

FIG. 4 shows some options for installations of wireless sensing module.

FIG. 5 illustrates method of operation of wireless sensing modules according to the present invention.

### DETAILED DESCRIPTION

### First Embodiment

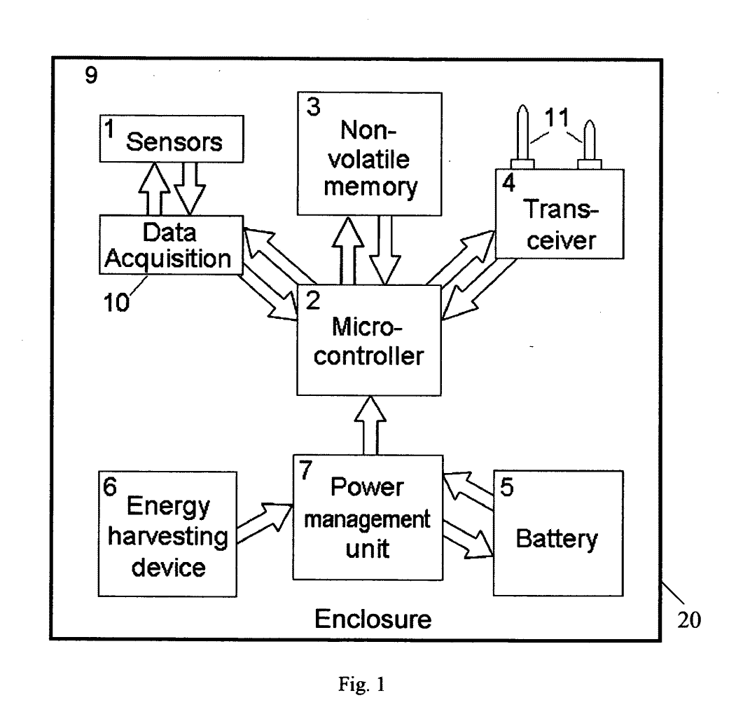

FIG. 1 shows a block diagram of a wireless sensing module 20 according to the present invention. The wireless sensing module 20 comprises a set of sensors 1, including at least one sensor of a physical parameter, a microcontroller 2, a non-volatile memory 3, a transceiver 4 with at least one antenna 11 and data acquisition hardware 10. The wireless sensing module 20 is powered by at least one battery 5. In many cases it is preferable to use several batteries 5. At least one battery providing power to the wireless sensing module 20 is a rechargeable or secondary battery. The wireless sensing module 20 also contains an energy harvesting device 6, which can harvest some energy from the environment. The harvested energy is transformed to electrical energy by this device and the output voltage is supplied to the power management unit 7. The power management unit 7 or power management circuit conditions the output voltage of the energy harvesting device 6 and uses the conditioned signal to charge the battery 5. The wireless sensing module 20 has at least one printed circuit board (not shown in FIG. 1). The sensors 1, the data acquisition hardware 10, the microcontroller 2, the non-volatile memory 3, the transceiver 4, at least one battery 5, at least one energy harvesting device 6, the power management unit 7, and at least one antenna 11 are electrically connected to the at least one printed circuit board. In order to provide mechanical, chemical, electrical and environmental protection of the components and extend service life of the wireless sensing module 20 the enclosure 9 contains all listed above electrical components of the wireless sensing module 20. More detailed description of the components of the wireless sensing module is provided below in the section “Components used in the wireless sensing modules”.

The microcontroller 2 controls the wireless sensing module 20 by executing a code. The microcontroller receives the digital measurement data, transfers the digital measurement data, processes the digital measurement data and transfers results of the measurement data processing.

The microcontroller 2, the set of sensors 1, the memory 3, and the transceiver 4 can operate in two modes—active mode and sleep mode. Operating the wireless sensing unit in active mode is referred later as a session.

During a session, the sensors 1 make measurements and generate electrical output signals proportional to the measured physical parameters. Data acquisition hardware 10 acquires sensor output signals, converts them into digital measurement data and transfers the data to the microcontroller 2. Microcontroller 2 can either save raw data in the non-volatile memory 3 or perform data pre-processing, for example, averaging of consecutive measurements or making data corrections based on data from sensors of environmental parameters, and save pre-processed or corrected data in the non-volatile memory 3. From time to time transceiver 4 transfers data from non-volatile memory 3 to an outside data collector. The data transfer can be done by both direct communication with the data collector or by transferring data to the data collector through other wireless sensing modules.

In the sleep mode, the sensors 1, the non-volatile memory 3, and the transceiver 4 do not perform measurements, data storing, and data transmitting, correspondingly, and consume significantly less power and current than when in active mode. In sleep mode, the microcontroller 2 suspends its clock and consumes much less power than in active mode.

Switching from sleep mode to active mode happens either at a predetermined time or as a result of an external event. Switching from active mode to sleep mode happens either after performing all required operations in active mode or at a predetermined time. The latter can happen, for example, if one of the operations that normally should be performed in the active mode was not performed despite several attempts. Failure to establish wireless communication despite multiple attempts can be an example of a situation when switching from active mode to sleep mode can be done by timeout signal in order to keep power consumption under control. Time can be measured using an oscillator and a counter. Internal sleep-mode clock, internal oscillator of the microcontroller 2, quartz crystal or a real time clock can be used to determine the switching time.

Although switching between active mode and sleep mode can allow for a significant reduction in average power consumption it might not be enough to provide the required service life of the wireless sensing module. Using energy harvesting device 6 is another important resource of extending service life of the wireless sensing module. Different energy harvesting devices can be used by the wireless sensing modules, including photovoltaic energy harvesting device located inside the enclosure 9, photovoltaic energy harvesting device embedded into the enclosure 9, electromagnetic vibration energy harvesting device, piezoelectric vibration energy harvesting device, electrostatic vibration energy harvesting device, thermoelectric energy harvesting device, energy harvesting device transforming nuclear energy into electrical energy and combination of the above.

Electrical energy generated by the energy harvesting device 6 in many cases requires conditioning before it can be used to charge the battery 5. This is done by the power management unit 7. Conditioning of the output voltage of the energy harvesting device 6 can include converting of AC output to DC signal, DC to DC conversion, filtering, voltage limiting, and storing electrical energy in a reactive element—capacitor or inductor.

It is desirable to use such energy harvesting device 6 that transfers, on average, more energy to the battery 5 per day or per week than the sum of (a) average amount of energy required to support the wireless sensing module for the same period of time and (b) average amount of energy lost by the battery 5 due to its natural self-discharge and/or loss of capacity over time. However, it is not necessary. Even smaller amounts of energy generated by the energy harvesting device 6 can dramatically extend service life of the wireless sensor module.

Power management unit 7 can be used to monitor the condition and state of charge of the battery. Battery life and, consequently, service life of the wireless sensing module can be extended by maintaining optimum level of battery charge, by minimizing number of charging cycles, limiting charging current and providing optimum level of operating discharge. These measures lead to slower decrease of battery capacity over time.

The wireless sensing module can have an additional energy storage component for supplying power to components of wireless sensing module in case of battery failure. This additional energy storage component is chosen from the group of energy storage components consisting of: a capacitor, a backup battery, and a fuel cell.

Assembly and packaging of the wireless sensing module is key to the realization for potential of extended service life created by using both active and sleep mode of the wireless sensing module, using energy harvesting and using power management capabilities discussed above.

All electrical connections within the wireless sensing module are, preferably, made using soldering or welding and protected by at least one layer providing a barrier for moisture and oxygen.

The wireless sensing module can have hermetic, near-hermetic, water-proof or other environmentally protected enclosure 9 rated for indoors or outdoors applications depending on the location and the environment where the wireless sensing modules are installed. All electrical components of the wireless sensing module, including microcontroller 2, sensors 1, non-volatile memory 3, transceiver 4, battery 5, energy harvesting device 6, and power management unit 7 are protected mechanically, chemically, electrically and environmentally by placing all of them in such an enclosure. Packaging of the autonomous sensing module can be done in an inert atmosphere. Getters and substances absorbing/adsorbing moisture can be added inside the enclosure 9. Environmentally resistive protective materials can be used to cover components of the wireless sensing module, electrical lines, wires and electrical connections. At least a portion of the interior of the enclosure also can be protected with an environmentally resistive coating.

Some sensors located in the wireless sensing module may have a portion exposed to the environment while their bond pads and wires are protected from the environment and sensor's interface with the enclosure is properly sealed. For example, an atmospheric pressure sensor, wind sensor or microphone may have a diaphragm or other part on one side of the die exposed to the environment while the other side of the sensor with bond pads can be facing interior of the enclosure.

### Second Embodiment

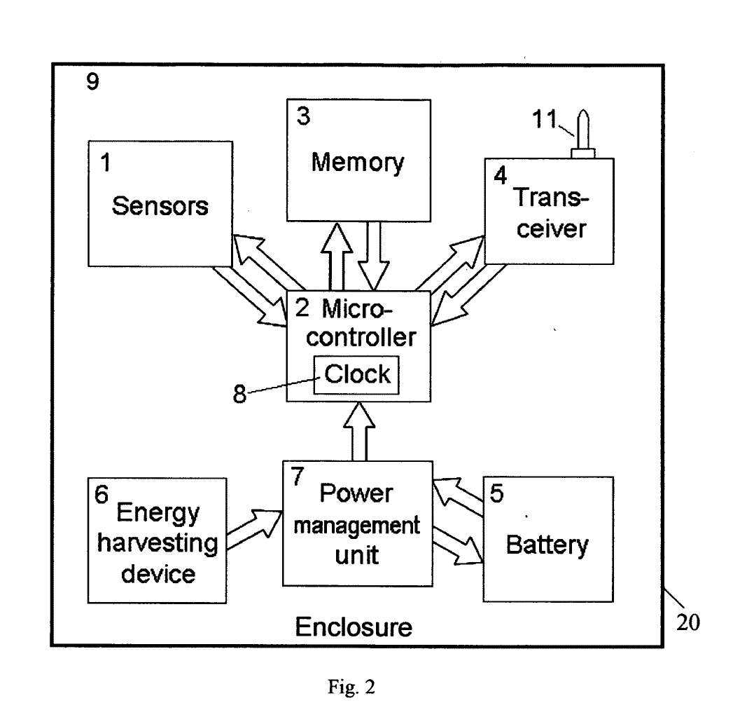

FIG. 2 shows a block diagram of a wireless sensing module 20 according to the present invention.

The wireless sensing module 20 contains a set of digital sensors 1 containing at least one digital sensor of a physical parameter, a microcontroller 2, a non-volatile memory 3, and a transceiver 4 with at least one antenna 11. Microcontroller 8 is used to generate a sleep-mode clock, which is used to wake up microcontroller. The wireless sensing module 20 is powered by at least one battery 5. At least one battery providing power to the wireless sensing module 20 is a rechargeable or secondary battery. The wireless sensing module 20 also contains an energy harvesting device 6. The output voltage of the energy harvesting device is conditioned by the power management unit 7 and used to charge the battery 5. The sensors 1, the microcontroller 2 with sleep-mode clock 8, the non-volatile memory 3, the transceiver 4, at least one battery 5, at least one energy harvesting device 6, the power management unit 7, and at least one antenna 11 are electrically connected to at least one printed circuit board (not shown in FIG. 2). Mechanical, chemical, electrical and environmental protection of the components of wireless sensing module is provided by enclosure 9.

Operation of the wireless sensing module according to the second embodiment is similar to that described in the first embodiment. Using digital sensors simplifies data acquisition. Digital data can be acquired by a microcontroller without the need for special data acquisition hardware. Using real time sleep-mode clock 8 simplifies measurements of time intervals.

### Third Embodiment

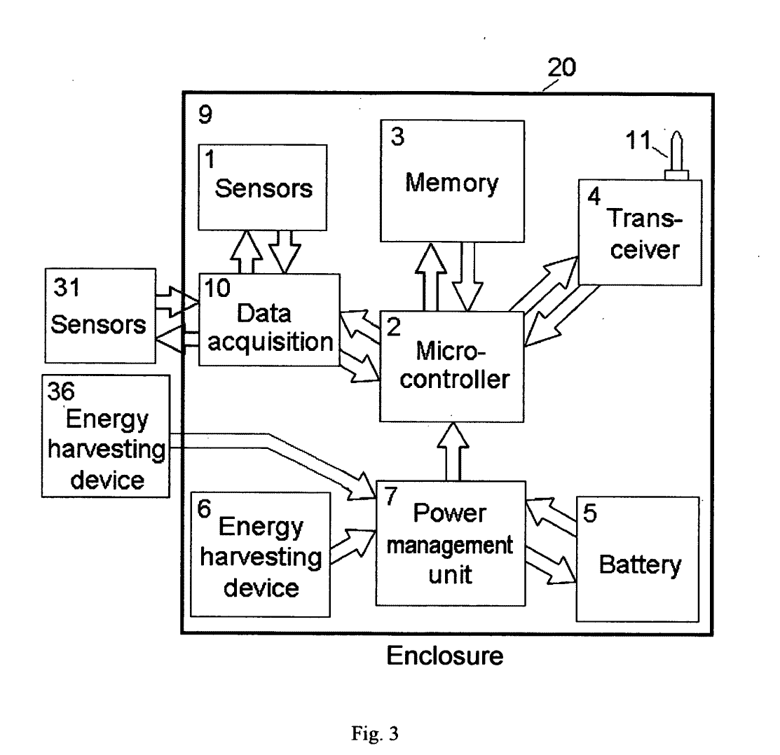

FIG. 3 shows a block diagram of a wireless sensing module 20 according to the present invention. The wireless sensing module 20 contains a set of sensors 1 containing at least one sensor of a physical parameter located inside the enclosure 9 and at least one external sensor 31 of a physical or a chemical parameter located outside the enclosure 9, a microcontroller 2, a non-volatile memory 3, data acquisition hardware 10, and a transceiver 4 with at least one antenna 11. The wireless sensing module 20 is powered by at least one battery 5. At least one battery providing power to the wireless sensing module 20 is a rechargeable or secondary battery. The wireless sensing module 20 also contains at least one energy harvesting device 6 either located inside the enclosure or embedded in it and at least one external energy harvesting device 36. The output voltage of energy harvesting devices is conditioned by the power management unit 7 and used to charge the battery 5. The sensors 1, the data acquisition hardware 10, the microcontroller 2, the non-volatile memory 3, the transceiver 4, at least one battery 5, at least one energy harvesting device 6, the power management unit 7, and at least one antenna 11 are electrically connected to at least one printed circuit board (not shown in FIG. 2). Mechanical, chemical, electrical and environmental protection of the components of wireless sensing module is provided by enclosure 9.

Operation of the wireless sensing module according to the third embodiment is similar to that described in the first embodiment. However, external components can be less protected from the environment. They can fail due to mechanical, chemical, radiation-based or other type of damage. This type of failure can cause changes in electrical connections of the external components and, in some cases, it can result in parasitic short-circuit connections. It is important that this type of failures do not result in uncontrolled current draw from the battery 5. In order to provide protection against failure of external energy harvesting device 36 the power management unit 7 can sense its output voltage and the current flow from the power management unit 7 to the energy harvesting device 36 can be limited to a very low value. Protection against failure of an external sensor 31 can include powering it up only during a short period of time when measurements should be made, limiting current that can flow to the external sensor 36, and evaluating measurement results provided by the sensor. If measurement results fail to meet predetermined credibility criteria the code can mark the external sensor as inactive or failed and stop powering it completely. Such credibility criteria can include initial or average level of signal, current consumption, variation of the output signal, standard deviation of the output signal, parameters of frequency spectrum of the output signal and others. In general, the wireless sensing module hardware provides protection against electrical failure of any external sensor. As a result of this protection such electrical failure does not result in an average current discharging the batteries faster than what is used during normal operation of the wireless sensing module.

### Forth Embodiment

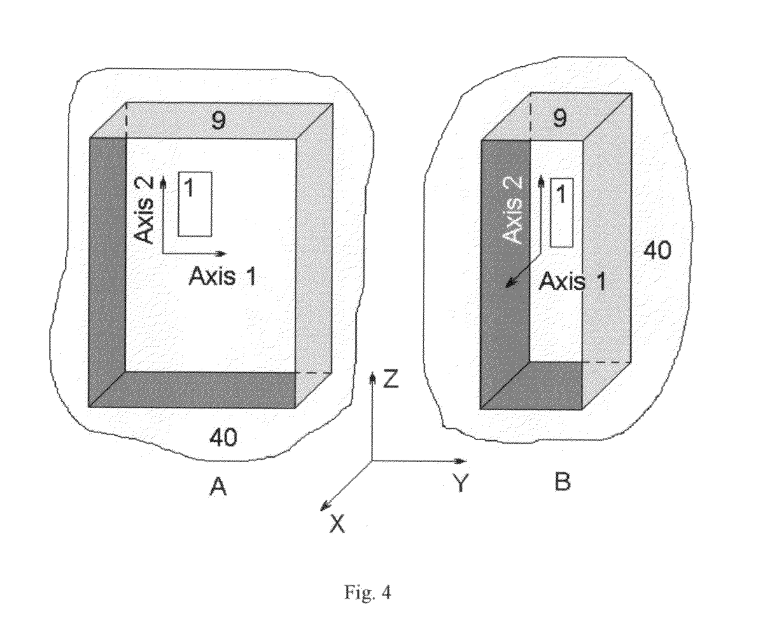

FIG. 4 shows a wireless sensing module 20 with a sensor 1 located inside the enclosure 9. The sensor is mounted on a structure 40. The sensor 1 has two sensitive axes—axis 1 and axis 2. In FIG. 4A the sensitive axes of the sensor 1 are oriented along axes Y and Z of a Cartesian coordinate system, where Z can be a vertical axis parallel to gravity vector or to magnetic field of Earth and Y axis can be a significant axis for the structure 40, as for example, a longitudinal axis of a bridge or a direction parallel to a major wall of a building. In order to orient sensitive axes of the sensor along axes X and Z it would be necessary either to change orientation of sensor 1 inside the wireless sensing module or have another sensor (not shown) with different orientation of sensitive axes inside the wireless sensing module 20. Changing of sensor 1 orientation can be achieved by using a design of wireless sensing module that allows for more than one mounting option of at least one printed circuit board inside the wireless sensing module; by using a design of the enclosure 9 that allows for using any of at least two non-parallel side walls of the enclosure 9 for its mounting during installation of the wireless sensing module (as shown in FIG. 4b).

### Fifth Embodiment

Operation of a wireless sensing module that allows for energy savings is extremely important for extending service life of wireless sensing modules according to the present invention. Saving energy, for example by reducing average operating power, can result in smaller number of secondary battery recharging cycles. Smaller number of recharging cycles results in extending service life of the secondary battery and the wireless sensing module.

Many secondary batteries allows for a limited number of recharging cycles. For example, number of recharging cycles can be limited by 3000, 1000 or even 300. If such batteries are used then it is necessary to ensure that average time between recharging cycles is at least equal to about 2 days, 6 days and 18 days, correspondingly, in order to allow for 15 years of rechargeable battery operation.

Most of the energy is used for wireless communications. The amount of energy used for wireless communications is proportional to the time required for such communications. Wireless data transfer can be the most energy consuming operation. Therefore, reduction of the amount of data transfer from wireless sensing modules can result in significant energy savings. In order to reduce the amount of data transfer through wireless communications the following options can be used: (a) number of sessions can be minimized; (b) short sessions can be used; (c) raw measurement data collected during a session can be pre-processed; (d) error correction can be implemented in order to minimize number of repeats during data transfer.

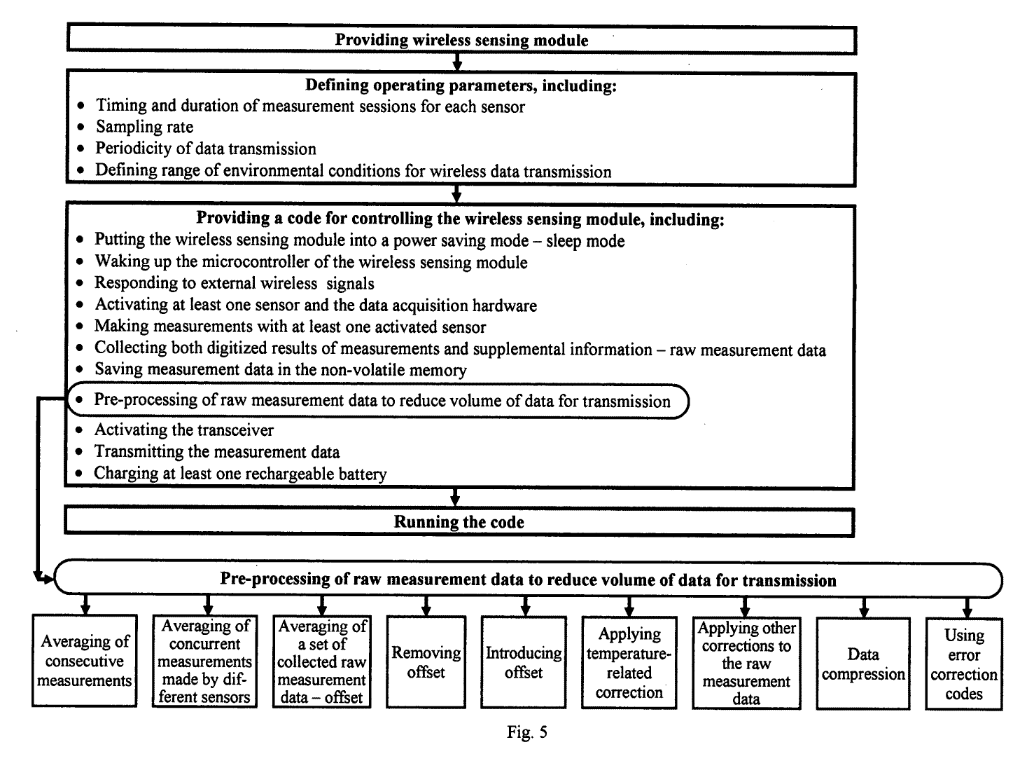

The first two options are related to system-level implementation that is not discussed in this patent application. The last two options can be accomplished by using the following operating method for the wireless sensing module illustrated in FIG. 5.

A wireless sensing module, as described in the first three embodiments, can be provided. The wireless sensing module comprises at least one sensor generating output electrical signals in response to a measurand acting on the at least one sensor and in response to qualified events; data acquisition hardware acquiring output electrical signals from at least one sensor and converting it into digital measurement data; a microcontroller having a clock rate, the microcontroller receives, processes and transfers the digital measurement data; non-volatile memory for storing the measurement data and results of the measurement data processing; at least one transceiver for wireless communication with external wireless devices; at least one battery, including at least one rechargeable battery, providing electrical power to the components of the wireless sensing module; at least one energy harvesting device for converting energy from the environment into electrical energy; a group of components forming a power management circuit or power management unit for charging of at least one rechargeable battery from at least one energy harvesting device; at least one sleep-mode clock; at least one antenna; and at least one printed circuit board. At least one sensor, the data acquisition hardware, the microcontroller, the non-volatile memory, at least one transceiver, at least one battery, at least one energy harvesting device, the components forming the power management circuit, and at least one antenna are electrically connected to at least one printed circuit board. All the above mentioned components can be placed in an environmental enclosure. As it has been discussed in the third embodiment, the wireless sensing module can also have external components, including sensors and energy harvesting devices.

Operating parameters of wireless sensing modules are defined at the next step. The operating parameters include at least timing and duration of measurement sessions for each sensor and its sampling rate; periodicity of data transmission; and a range of environmental conditions for wireless data transmission. Operating parameters can be changed with time. For example, a wireless sensing module can be required to make two measurements per day every day for the first six months of operation and after that the requirement can be dynamically changed to perform the same two measurements every other day.

A code for controlling the wireless sensing module is provided at the next step. The code should allow for executing at least the following steps: putting the wireless sensing module into a power saving mode (also referred as sleep mode); waking up the microcontroller of the wireless sensing module; responding to external wireless signals; responding to external events such as shock and/or vibrations exceeding a predetermined threshold; activating at least one sensor and the data acquisition hardware; making measurements with at least one activated sensor and collecting both digitized results of measurements and supplemental information (also referred as raw measurement data); saving measurement data in the non-volatile memory; pre-processing of the raw measurement data; activating the transceiver; transmitting the measurement data; charging at least one rechargeable battery. The supplemental information can include time stamps, temperature and values of other environmental parameters at the time of measurements.

During operation the microcontroller runs the code. The code and operating parameters can be modified through the wireless links.

In order to minimize average power consumption and extend service life of the wireless sensing module the raw measurement data is pre-processed by the microcontroller and the volume of data to be transmitted by the transceiver is reduced in comparison with the volume of raw measurement data. The pre-processing can include operations selected from the group of operations consisting of: averaging of consecutive measurements, averaging of concurrent measurements made by different sensors, calculating an average for a set of collected raw measurement data (also referred as offset), removing offset, introducing offset, applying temperature and other corrections to the raw measurement data, data compression, using error correction codes and combination of the above.

Pre-processing of raw measurement data can result in some reduction in the volume of the data. Decrease in the volume of data can be characterized by the difference between the volume of raw measurement data and pre-processed measurement data. This difference is called “reduced volume”. The amount of energy required for data pre-processing is determined by the average power consumption of both the microprocessor and the non-volatile memory and the time required for such operations. This amount of energy is then compared with the amount of energy required to transfer the amount of data equal in volume to the reduced volume. We have found that in many cases a relatively simple data pre-processing can result in 50% or more reduction in the volume of raw measurement data. For example, averaging of measurement data can be a very effective way to both reduce volume of the data and increase signal-to-noise ratio. Removing or introducing offset can allow for effective data compression. For example, if each measurement result is represented as a two-byte word then in some cases offset introduction can allow for representing all variations between different measurements within just one byte. The other byte can be the same for all measurements.

Charging of the secondary battery is also a critical step for extending service life of the wireless sensing module. Both full charge and deep discharge can shorten operating life of the secondary batteries. Besides that, charging the battery at very low temperatures and very high temperatures also can result in damaging the battery. Therefore, the method of operation of the wireless sensing module further comprises steps of providing means for sensing the state of charge of at least one battery (later referred as a “fuel gauge”) and providing at least one temperature sensor within the wireless sensing module. Decision about charging the secondary battery is made when: (a) the battery charge is below a pre-determined threshold and (b) temperature is within a pre-determined range. Charging of the secondary battery is performed up to a pre-determined state of charge. The target state of charge can be changed with time reflecting some loss of capacity by the battery.

In some cases the battery can be depleted and its charging can not be allowed due to temperature restrictions. In such situation the microprocessor can decrease power consumption by shutting down or transferring to sleep mode some electrical components for a predetermined period of time to allow for battery recovery.

Another resource for energy savings is related to dynamically adjusting clock rate of the microcontroller based on environmental conditions, data collection rate and required amount of computation. The lower is the clock rate—the lower the power consumption.

Another important aspect of extending service life of the wireless sensing module is monitoring the “health” of its own components. This can be effectively done by using components having built-in self-test and performing diagnostics of other components or circuits of the wireless sensing module. Self-test and other diagnostic testing options are periodically used to evaluate current status and life expectancy of components. This can include self test of at least one sensor, non-volatile memory wear management, defect mapping, active code integrity check, backup code integrity check, clock drift test, data path check from the microcontroller to at least one sensor, data path check from the microcontroller to at least one transceiver, data path check from the microcontroller to non-volatile memory, battery test, and combination of the above.

Another aspect of the disclosed method of operation of wireless sensing modules is the use of data from temperature sensor and sensors of other environmental parameters for making corrections to some measurements made by other sensors, including time interval measurements made by clocks. Correction of clocks is important for better synchronization of clocks of different wireless modules.

Components Used in Wireless Sensing Modules

Sensors

Selection of the sensors 1 and their target parameters depend on the type of monitoring structure, application, and the goals of monitoring. For example, accelerometers can be used for vibration monitoring of the condition of highways, automotive road bridges, railroad bridges and buildings. In active mode the accelerometers can measure single-axis, two-axis or three-axis (vector) acceleration over time. Further processing of accelerometer signals can provide information on the resonance frequencies, oscillation modes of the structures, spectral density of the signal. All this information can be used in the data analysis. Vibration of bridges under the load of multiple running vehicles can be quite significant. The peak acceleration can be as high as tens of milli-g's or mg (g—free fall acceleration). For example, M. Q. Feng and Y. Chen reported peak acceleration from traffic of about 25 gals (1 gal=1 cm/s²) or about 25 mg (1 mg=0.981 gal) and peak acceleration from a moderate earthquake with a epicenter located about 65 miles from the bridge of about 13 gal≈13 mg. Measurements made with wireless sensing modules 3DAT-009 fabricated by Green SHM Systems showed that peak accelerations due to vibrations caused by a train arriving at a station located at a railroad bridge can be as high as 80 gals. There are many accelerometers available on the market that can be used to measure such acceleration. For example, capacitive acelerometers manufactured by ST Microelectronics, Analog Devices, Kionix having 2 g range; piezoresistive accelerometers manufactured by Hitachi Metals also having 2 g range and other devices. Resolution of many low-g accelerometers can be as high as 1 mg and some devices have resolution in the range of 0.2-0.5 mg. If the monitored structure is a building then it is likely to have a significantly smaller peak acceleration, which can be below 10 mg—about an order of magnitude smaller than that for bridges.

Stress at critical points is another parameter that can provide important information about condition of monitored structure. Stress can be measured with help of foil strain gauges, vibrating wire strain gauges and other devices known in the art. Stress sensors can be used as external sensors. For example, vibrating wire devices manufactured by Geokon can be used as external stress sensors.

In another example the structure for monitoring can have a mechanism with rotating parts as for example a rotating stage, an attraction in a park, etc. Some additional sensors might be added to the set of sensors to monitor condition of this structure. In particular, a gyroscope and an angular accelerometer can be useful in many cases. Such devices are also commercially available. For example, two-axis capacitive gyroscopes are manufactured by Invensense and ST Micro-electronics.

Therefore, depending on the structure to be monitored, the monitoring application and the goals of monitoring a set of sensors can contain different types of sensors, including a linear accelerometer, a vibration sensor, a microphone, a strain sensor, a stress sensor, a deformation sensor, a jointmeter, a pressure sensor, temperature sensor, a tilt sensor, a force sensor, a gyroscope, an angular accelerometer, a humidity sensor, a wind sensor, a magnetic sensor, a proximity sensor, an image sensor, an optical sensor, a photosensitive sensor, a microphone, an acoustic sensor, a corrosion sensor, a chemical sensor, and a GPS module.

In many cases accuracy of measurements can be affected by influencing parameters such as temperature. Temperature errors of some sensors can be comparable to the useful signal. In order to increase accuracy of measurements the wireless sensing module can be equipped with a temperature sensor. Signal filtering also can be used to increase signal-to-noise ratio.

Depending on the application, two or more sensors of one type can be used within one autonomous sensing module. This can be done to increase reliability of the autonomous sensing modules and increase accuracy of the measurements.

Sensors with both analog and digital output can be used. However, using sensors with digital or frequency output is preferable because such sensors require either no additional hardware or simple additional hardware for digitizing their output signals

Sensors can have a self test feature that can be used for verification of sensor functionality.

Sensors also can have a self calibration feature, which can be used for verification of some sensor parameters as, for example, value of initial output signal.

Non-Volatile Memory

Non-volatile memory 3 is preferably a solid state memory. This type of memory has no movable parts and can provide required reliability and service life. Flash memory that allows more than one hundred thousand write cycles is suitable to store measurement data. It is desirable to have enough memory to store all measurement data generated by the sensors 1 within at least two sessions and, preferably, within all sessions during a pre-determined period of time that can be as long as one week or even one month. This will eliminate data loss in case of absence of communication or communication failure in one of the sessions as well as retain measurement data in case of temporary power loss after a natural disaster.

The amount of generated data depends on the structure, the application and the goals of monitoring. However, it can be estimated for some typical applications. For example, in case of monitoring of conditions of buildings and bridges the frequency spectrum for the structure is likely to be below 20-30 Hz. However, quick decay of the oscillations might force using relatively high sampling rate of 100-400 Hz.

If the measurements are made for 10 minutes and three channels are used (as for a 3D accelerometer) then 60,000 to 240,000 results can be generated at 100 Hz and 400 Hz sampling rate, correspondingly. Assuming that each result fits into a 16-bit word and that the memory has capacity to hold the results for two sessions, the required memory capacity can be estimated to be 2 Mb to 8 Mb. Keeping measurement data for larger number of sessions will require proportional increase in memory size.

Transceiver

The transceiver 4 uses a wireless channel to communicate with a data collector or base station. Transceiver 4 also can be used to communicate with other wireless sensing modules. Transmission can be done using protocols under 802.15.4 standard, which allows for data transmission within both 868/915 MHz frequency bands and 2.4 GHz frequency band with rates up to 250 kb/s. Alternatively, 802.11 family of protocols can be used, which can allow for even higher data transmission rates.

There are commercially available data transfer modules provided by many manufacturers such as Texas Instruments, Freescale Semiconductor, Cypress and others. WSN802g module developed by RF Monolithics uses 802.11g protocol and provides data transfer rates up to 2 Mb/s. MC1322 family from Freescale Semiconductor are 802.15.4/ZigBee compliant. Devices of MC1322 family that operate in 2.4 GHz band can be powered by a voltage ranging from 2.0 V to 3.6 V. Typical current consumption is below 30 mA both in receive and transmit mode. The modules have 96 KB of RAM and 128 KB of flash memory. Current consumption in hibernation mode is below 1 μA with retained 8 KB SRAM contents.

Microcontroller

A microcontroller can be based on a processor or a discrete state machine, an analog-to-digital converter (ADC), a digital signal processing chip or other ASIC or commercially available integrated circuit. The microcontroller can have different blocks including processor, memory, ADC, digital-to-analog converters (DAC), amplifiers, comparators, multiplexers, clock, standard input and output ports for data exchange and other blocks. Being in active mode, the microcontroller can run a code to perform required operations, including loading or activating a code, which can be stored in a non-volatile memory of the wireless sensing module or in non-volatile memory or in the RAM memory of the microcontroller itself; self-testing; establishing communications with the set of sensors and with the transceiver; acquiring data from the set of sensors; if necessary, performing data pre-processing or data conditioning, which can include offset correction, introduction of offset, averaging of consecutive measurements from one sensor, adding or averaging of concurrent measurements from different sensors, converting a frequency signal into digital form, multiplying of digital signals by a pre-determined coefficient, calculating a correction factor based on measurements provided by some sensors and using this correction factor in processing of measurement data provided by other sensors and other operations that can be necessary for conditioning of the sensor signal; temporary storing a group of measurement results in a volatile memory; transferring the measurement data from the volatile memory to the non-volatile memory 3; some data control, including data quality control; control of data transfer to the non-volatile memory 3; control of data transfer to the transceiver 4; generating and transferring to the data collector or base station messages related to different failure modes and/or non-standard situations diagnosed either within the wireless sensing module or through the data control.

Many microcontrollers suitable for the autonomous sensing modules are available on the market from different companies, including Texas Instruments (digital signal processors), Cypress (PSoC family), Intel (microprocessors). Exact specs for the microcontroller depend on the application. The EEPROM memory can store a code for the microcontroller. This part of memory can have a size of 8-128 KB.

Sleep-Mode Clock

The sleep-mode clock is used to wake up the microcontroller. This circuit is constantly powered. The power consumption depends on the clock base frequency and increases as the frequency increases. A very low sleep-mode clock frequency can be used for this clock circuit, thus decreasing power consumption. This circuit can consume less power than a circuit used in electric watches. Real time sleep-mode clocks can be used in the wireless sensing modules as well.

Energy Harvesting Device

Energy harvesting device, preferably, should provide average power of at least 1 mW. Larger average output power is desirable. Output voltage of the energy harvesting device, preferably, should be in the range of 4-20 V.

Harvesting energy from different ambient sources can be used, including solar radiation, mechanical energy of vibration, wind energy, thermal energy, energy of electromagnetic waves in RF range, energy of radioactive particles and some others. Not all of these sources have the same potential for energy harvesting when the 1-10 mW range of harvested power is targeted for many years of autonomous work.

Even small size solar panels are capable of providing this average level of power during a day. Many types of solar cells are available in the market. However, in some applications photovoltaic elements (or a transparent protective cover for the elements) can be contaminated over time and this can result in a decrease of harvested energy. There are options of using such element if natural “cleaning” due to rain and wind is sufficient to keep the element effective for a very long period of time.

Harvesting of mechanical energy is also a good option. A piezoelectric wind harvester working in bending mode can be an attractive option. This type of energy harvesting device can work for a very long time. By design, it can be protected from large deflections, which can cause plastic deformation or other damage of mechanical parts by a strong wind or mechanical contact between parts of the energy harvesting device and a foreign object. Such devices are available on the market. For example, Advanced Cerametrics Incorporated manufactures energy harvesting devices utilizing piezoelectric fibers having extremely long life time (“forever” according to the company). The piezoelectric harvesters utilize PZT for energy harvesting, providing a high voltage suitable for use in battery charging. Devices having output corresponding to tens of milliwatts of continuous power are available.

Energy harvesting from devices having a vibrating mass is also possible. Vibration harvesters can be more effective if the monitored structure either experiences vibrations with frequencies above 10 Hz and, preferably, above 100 Hz or experiences high accelerations. Vibration energy harvesting devices often can be used in wireless sensing modules for monitoring of rotating structures. For example, wireless sensing module can be placed on a blade of a wind turbine. Wind turbine blades can be as long as 70 meters and they can make about 20 rotations per minute. Peak acceleration due to rotation can be as high as 30 g. Energy harvesting devices can be effective in such application.

Thermoelectric harvesting using Seebeck effect potentially can be used in some applications. However, the Seebeck coefficient for most of materials suitable for thermoelectric harvesting is in the order of 0.2-0.3 mV/K. Taking into account that temperature difference at the working setup of the wireless sensing module is likely to be less than 10 K, one can conclude that thousands of thermocouples should be combined in order to obtain voltages suitable for charging a battery. Therefore, suitable applications should be identified based on a potential for a large temperature gradient within the area where the monitoring device can be installed.

Radioactive energy sources also can be used for powering up the autonomous sensing module.

Preferably, at least one energy harvesting device is located inside the package of the wireless sensing module. A solar panel can be placed inside the enclosure 9—it can have a transparent window for the solar panel or a solar panel can be embedded in at least one of the walls of the enclosure 9. Vibration, thermoelectric harvesting devices and radioactive energy source also can be located inside the wireless sensing module. In such cases enclosure 9 allows for excellent protection of the energy harvesting device/source of energy.

In some cases the wireless sensing module can be electrically connected to an existing energy harvesting device, as for example an existing solar panel. In such a case there may be no need for an additional energy harvesting device within it. In some cases it can be advantageous to separate the energy harvesting device and the wireless sensing module in order to get both more energy and better protection for the wireless sensing module. For example, the wireless sensing module can be protected from direct sunlight and corresponding heating and the energy harvesting device can be exposed to direct sunlight.

Power Management Unit

The power management unit or power management circuit contains interfaces with the battery and with the energy harvesting device, provides continuous power supply to the microcontroller 2 and sleep-mode clock. The microcontroller 2 controls power supply to the set of sensors 1, non-volatile memory 3 and transceiver 4. The power management unit also contains means for sensing state of the charge of at least one rechargeable battery—fuel gauge. Similar fuel gages can be used to sense state of charge of other batteries, including primary batteries.

The circuit for battery charging should be selected according to the type of energy harvesting device. However, in all cases, the energy harvesting device can be connected to the battery through a charging circuit having an asymmetric IV curve. If the voltage supplied by the energy harvesting device is larger than the battery voltage by a certain value, i.e. the battery can be charged when the charging circuit has a low resistance and allow the current to flow into the battery. If the output voltage of the battery is higher or even somewhat smaller, but close to the output voltage of the energy harvesting device, then the charging circuit disconnects the energy source from the battery to prevent the battery from being discharged. Typically the charging circuit contains also a rectifier and at least one component for temporarily storing energy, such as a capacitor and/or an inductor, and for smoothing output voltage used for battery charging. These functions can be provided by circuits containing capacitors and/or inductors. Circuits for charging the batteries are known and commercially available from several providers, including Maxim, Linear Technology, Mide Technology Corporation. Linear Technology has several ICs for interfacing energy harvesting devices and batteries.

The power management unit can be fabricated as a circuit containing components providing all the above described functions and located on the same printed circuit board as all other components of the wireless sensing module.

Battery

The battery used in the autonomous sensing module has 25+ years of life time. Currently there are some batteries with 25+ years of life time. Tadiran Batteries manufactures lithium batteries with a voltage of 3.6 V and capacity of 2400 mAh having self discharge of less than 1% per year. Tadiran started deploying batteries in 1984. First remote meters utilizing Tadiran batteries have been installed in mid-1980's and some of these devices are still functioning today and keep about 25% of charge. This corresponds to service life of more than 25 years. This type of batteries can be used in devices that have very long periods between sessions or devices having both primary and secondary batteries with primary battery serving as a backup battery. In such systems the primary battery can be used only if there is not enough voltage from the secondary battery to support the wireless sensing module in active mode.

Switching to the primary battery can result in transmission of an alarm signal. The alarm signal can be transmitted either during every session or with other periodicity. The primary battery can support the wireless sensing module for at least several months and in many cases longer than one year allowing ample time for either maintenance or replacement of the wireless sensing module. Hoppecke FNC manufactures rechargeable NiCd batteries with 25+ years of life time. The batteries allow for more than 3000 deep discharge cycles. Rechargeable lithium batteries with 25+ years of life time are also available from Quallion LLC.

Antenna

Wireless sensing modules can use more than one antenna. For example, a directional antenna can be used for low power transmission of wireless signals by the transceiver while a high gain antenna can be used for receiving wireless signals.

Example of Wireless Sensing Module Implementation

Wireless sensing module 3AT-09 developed and fabricated by Green SHM Systems utilizes 3-axis digital acceleration sensor, temperature sensor and real-time clock. The wireless sensing module is powered by one primary and one secondary battery. The accelerometer has bandwidth from zero to 1500 Hz. It is sensitive to both gravity and accelerations generated by vibrations. The accelerometer can make measurements at different rates, including 50 Hz, 100 Hz, 400 Hz and 1000 Hz. The data rate is selectable. The module employs a low-power microcontroller having an 8051-based microprocessor and supporting peripherals such as ADC, PWM and power management unit. The microcontroller can operate at frequencies ranging from 25 MHz to 38 KHz. The size of non-volatile memory is either 8 MB or 16 MB. A radio operating at 2.4 GHz is used. The module has a solar cell embedded into the enclosure and used to charge the secondary battery. The module allows for connection of up to 8 devices. In particular, an additional solar panel and other external or internal energy harvesting devices, vibrating wire strain gauge, humidity sensor, microphone and other sensors can be connected to the module. Current consumption in active mode does not exceed 30 mA while in sleep mode the module consumes less than 50 μA. Power management unit is equipped with fuel gauges monitoring state of charge of both batteries. Charging of the secondary battery is done on “as needed” basis. The real time clock is used as sleep-mode clock.

If the wireless sensing module operates in active mode for 10 minutes per day and remains in sleep mode for the rest of the day then battery discharge does not exceed 6.2 mA*h per day. Most of energy is provided by the secondary battery. It can lose about 5 mA*h per day while the primary battery can lose only about 1.2 mA*h per day. Using D-cell with capacity of 13,000 mA*h and about 1% self-discharge rate per year as a primary battery can allow for 20+ years of service life. The secondary battery can have capacity of about 2,000 mA*h and lose capacity at an average rate of 3% per year. This battery can be charged once in every 3-4 months providing less than 100 charging cycles in the first 20 years of service life.

All electrical components of the wireless sensing module 3AT-09 are assembled on one printed circuit board using industry standard soldering and welding processes and protected with an environmentally resistant coating. The module is packaged in NEMA-4X enclosure rated for both indoors and outdoors use.

### * * *

Although wireless sensing modules with extended service life can be used in multiple applications, the target applications for the wireless sensing modules described in this patent application include structural health monitoring, green buildings, environmental monitoring and smart infrastructure.

Structural health monitoring is a technique that is based on the deployment of a set of sensors on a structure selected for monitoring, making regular measurements that can include stress at critical points, vibration signature and environmental parameters. Other parameters, such as displacement of some parts of the structure, status of corrosion and others can be monitored as well.

Very different structures can be monitored using wireless sensing modules. In particular, the list of structures that can be monitored includes: a building, a bridge, a wall, a roof, a floor, stairs, a power line, a pipeline, a pipe, a levee, a dam, a part of a highway, a part of a road, a part of rail road, a stadium, a tank, a well, a pier, a sea platform, a fence, a gate, a light pole, a traffic pole, a pavement, an underground structure, an attraction.

In general, the wireless sensing module can be installed on the structure, inside the structure, outside the structure, near the structure, under the structure, or above the structure.

Although specific embodiments have been illustrated and described herein, this application is intended to cover any adaptations or variations of the present invention. Therefore, it is manifestly intended that this invention be limited only by the claims and the equivalents thereof.

We claim:

1. A wireless sensing module with extended service life comprising:
An environmental enclosure, and
the following electrical components:
at least one sensor of a physical parameter; said at least one sensor generates output electrical signals proportional to value of the physical parameter;
a data acquisition hardware acquiring output electrical signals from at least one sensor and converting it into digital measurement data;
a microcontroller controlling the wireless sensing module by executing a code, receiving the digital measurement data, transferring the digital measurement data, processing the digital measurement data and transferring results of the measurement data processing;
non-volatile memory for storing the measurement data, results of the measurement data processing;
at least one transceiver for wireless communication with external wireless devices;
at least one battery, including at least one rechargeable battery providing electrical power to the electrical components of the wireless sensing module;
at least one energy harvesting device for converting energy from the environment into electrical energy and generating an electrical voltage as a result;
a group of components forming a power management circuit for charging of at least one rechargeable battery from at least one energy harvesting device;
at least one antenna; and
at least one printed circuit board; at least one sensor of a physical parameter, the data acquisition hardware, the microcontroller, the non-volatile memory, at least one transceiver, at least one battery, at least one energy harvesting device, the components forming the power management circuit, and at least one antenna are electrically connected to at least one printed circuit board;
wherein in order to provide mechanical, chemical, electrical and environmental protection of the components and extend service life of the wireless sensing module the enclosure contains all electrical components of the wireless sensing module.

2. A wireless sensing module with extended service life for use in smart infrastructure applications, including structural health monitoring systems and green buildings, comprising:
an environmental enclosure, and
the following electrical components:
at least one sensor of a physical parameter; said at least one sensor generates output electrical signals proportional to value of the physical parameter;
a data acquisition hardware acquiring output electrical signals from at least one sensor and converting it into digital measurement data;
a microcontroller controlling the wireless sensing module by executing a code, receiving the digital measurement data, transferring the digital measurement data, processing the digital measurement data and transferring results of the measurement data processing;
non-volatile memory for storing the measurement data, results of the measurement data processing;
at least one transceiver for wireless communication with external wireless devices;
at least one battery, including at least one rechargeable battery providing electrical power to the electrical components of the wireless sensing module;
at least one energy harvesting device for converting energy from the environment into electrical energy and generating an electrical voltage as a result of that;
a group of components forming a power management circuit for charging of at least one rechargeable battery from at least one energy harvesting device;
at least one antenna; and
at least one printed circuit board; at least one sensor of a physical parameter, data acquisition hardware, the microcontroller, the non-volatile memory, at least one transceiver, at least one battery, at least one energy harvesting device, the components forming the power management circuit, and at least one antenna are electrically connected to at least one printed circuit board;
wherein in order to provide mechanical, chemical, electrical and environmental protection of the components and extend service life of the wireless sensing module the enclosure contains all electrical components of the wireless sensing module.

3. A wireless sensing module according to claim 2 wherein at least one sensor of a physical parameter is integrated with the data acquisition hardware and provides digital output signal.

4. A wireless sensing module according to claim 2 wherein energy harvesting device is selected from a group of energy harvesting devices consisting of: photovoltaic energy harvesting device located inside the enclosure, photovoltaic energy harvesting device embedded into the enclosure, electromagnetic vibration energy harvesting device, piezoelectric vibration energy harvesting device, electrostatic vibration energy harvesting device, thermoelectric energy harvesting device, and energy harvesting device transforming nuclear energy into electrical energy and combination of the above.

5. A wireless sensing module according to claim 2 wherein in order to provide a required position of sensitive axes of at least one sensor of a physical parameter with respect to the gravity field and with respect to the magnetic field of Earth design of the wireless sensing module is selected from a group of designs consisting of: a design that allows for more than one mounting option of at least one printed circuit board inside the wireless sensing module, a design that allows for using any of at least two non-parallel side walls of the enclosure for its mounting during installation of the wireless sensing module; and a design having at least two sensors with different orientation of their sensitive axes with respect to the gravity field and with respect to the magnetic field of Earth and combination of the above.

6. A sensing module according to claim 2 wherein in order to provide high reliability of the wireless sensing module it uses solid-state non-volatile memory, and all electrical connections between electrical components are non-separable permanent connections utilizing either soldering or welding.

7. A wireless sensing module according to claim 2 further comprising at least one external energy harvesting device selected from a group of energy harvesting devices consisting of: photovoltaic energy harvesting device, electromagnetic vibration energy harvesting device, piezoelectric vibration energy harvesting device, electrostatic vibration energy harvesting device, thermoelectric energy harvesting device, piezoelectric wind energy harvesting device, and energy harvesting device transforming nuclear energy into electrical energy and combination of the above, wherein power management circuit provides protection against electrical failure of any of at least one external energy harvesting devices and electrical failure of any of at least one external energy harvesting devices does not result in a current discharging the batteries faster than at normal operation of the wireless sensing module.

8. A wireless sensing module according to claim 2 comprising at least one directional antenna for low power transmission of wireless signals and at least one high gain antenna for receiving wireless signals.

9. A wireless sensing module according to claim 2 further comprising at least one external sensor selected from the group of sensors consisting of: a stress sensor, a strain sensor, a deformation sensor, a jointmeter, a tilt sensor, a vibration sensor, an accelerometer, a gyroscope, a microphone, an image sensor, a GPS module, an acoustic emission sensor, a photosensitive sensor, a temperature sensor, a humidity sensor, a wind sensor, a corrosion sensor, a magnetic sensor, a sensor of a physical parameter and a sensor of a chemical parameter, wherein wireless sensing module hardware provides protection against electrical failure of any of at least one external sensor and electrical failure of any of at least one external sensor does not result in a current discharging the batteries faster than at normal operation of the wireless sensing module.

10. A wireless sensing module according to claim 2 further comprising a real time clock.

11. A wireless sensing module according to claim 2 further comprising an additional energy storage component for supplying power to components in case of battery failure, said additional energy storage component is chosen from the group of energy storage components consisting of: a capacitor, a backup battery, and a fuel cell.

12. A wireless sensing module according to claim 2 having additional protection of components in order to enhance environmental protection of the wireless sensing module; said additional protection is chosen from the group of: use of the enclosure rated for outdoors applications, use of the enclosure rated for indoors applications, use of the enclosure having at least a near-hermetic sealing, placing a water absorbing material inside the enclosure, placing a getter inside the enclosure, using only soldered or welded electrical connections between the electrical components, covering of at least some of the electrical components by an environmentally resistive coating and covering of at least a portion of the enclosure by an environmentally resistive coating and combination of the above.

13. A wireless sensing module according to claim 2 wherein the power management circuit contains means for sensing the state of charge of at least one rechargeable battery—fuel gauge.

14. A wireless sensing module according to claim 2 wherein the power management circuit contains means for conditioning of the electrical voltage generated by at least one energy harvesting device before charging of at least one rechargeable battery.

15. A method of operation of a wireless sensing module comprising the steps of:
providing a wireless sensing module comprising:
an environmental enclosure, and
the following electrical components:
at least one sensor; said at least one sensor generates output electrical signals in response to a measurand acting on the at least one sensor and in response to qualified events;
a data acquisition hardware acquiring output electrical signals of at least one sensor and converting it into digital measurement data;
a microcontroller having a clock rate, the microcontroller receives the digital measurement data, transfers the digital measurement data, processes the digital measurement data and transfers results of the measurement data processing;
non-volatile memory for storing the measurement data and the results of the measurement data processing;
at least one transceiver for wireless communication with external wireless devices;
at least one battery, including at least one rechargeable battery, providing electrical power to the components of the wireless sensing module;
at least one energy harvesting device for converting energy from the environment into electrical energy;
a group of components forming a power management circuit for charging of at least one rechargeable battery from at least one energy harvesting device;
at least one clock;
at least one antenna; and
at least one printed circuit board; at least one sensor, the data acquisition hardware, the microcontroller, the non-volatile memory, at least one transceiver, at least one battery, at least one energy harvesting device, the components forming the power management circuit, and at least one antenna are electrically connected to at least one printed circuit board;
defining operating parameters, including
timing and duration of measurement sessions for each sensor and its sampling rate;
periodicity of data transmission;
range of environmental conditions for wireless data transmission;
providing a code for controlling the wireless sensing module; the code allows for executing at least the following steps:
putting the wireless sensing module into a power saving mode—sleep mode;
waking up the microcontroller of the wireless sensing module;
responding to external wireless signals;
activating at least one sensor and the data acquisition hardware;
making measurements with at least one activated sensor and collecting both digitized results of measurements and supplemental information—raw measurement data;
saving measurement data in the non-volatile memory;
activating the transceiver;
transmitting the measurement data;
charging the at least one rechargeable battery;
running the code,
wherein in order to minimize average power consumption and extend service life of the wireless sensing module the raw measurement data is pre-processed by the microprocessor and the volume of data to be transmitted by at least one transceiver is reduced in comparison with the volume of raw measurement data; the pre-processing includes operations selected from the group of operations consisting of: averaging of consecutive measurements, averaging of concurrent measurements made by different sensors, calculating average for a set of collected raw measurement data—offset, removing offset, introducing offset, applying temperature and other corrections to the raw measurement data, data compression, using error correction codes and combination of the above.

16. A method of operation of a wireless sensing module according to claim 15 wherein in order to extend the service life of at least one battery the method further comprises steps of:
providing means for sensing state of the charge of at least one battery—fuel gauge;
providing at least one temperature sensor within the wireless sensing module;
sensing the state of charge of the at least one battery utilizing a fuel gauge,
measuring temperature, and
managing at least one battery by using a method selected from the group of methods consisting of: charging the rechargeable battery from at least one energy harvesting device to a predetermined state of charge when the temperature is within a predetermined range; decreasing current consumption by shutting down or using sleep mode for at least some electrical components and devices for a predetermined period of time to allow for battery recovery and combination of the above.

17. A method of operation of a wireless sensing module according to claim 15 wherein at least some of its electrical components have self-test option and this self-test option is periodically used to evaluate current status and life expectancy of the wireless sensing module; the self-test includes at least one test selected from the group of: self test of at least one sensor, non-volatile memory wear management, defect mapping, active code integrity check, backup code integrity check, clock drift test, data path check from the microcontroller to at least one sensor, data path check from the microcontroller to at least one transceiver, data path check from the microcontroller to non-volatile memory, battery test, and combination of the above.

18. A method of operation of a wireless sensing module according to claim 15 wherein clock rate of the microcontroller is dynamically adjusted based on environmental conditions, data collection rate and required amount of computation.

19. A method of operation of a wireless sensing module according to claim 15 wherein at least one component of the wireless sensing module has temperature compensation.

20. A method of operation of a wireless sensing module according to claim 15 wherein the code allows providing updates, including updates selected from the group of: code update, update of operating parameters and combination of the above.
